(19) United States
(12) Patent Application Publication
(10) Pub. No.: US 2009/0143962 A1
(43) Pub. Date: Jun. 4, 2009

(54) METHOD AND DEVICE FOR SAVING AUTOMOBILE ENERGY

(75) Inventors: De-Hua TONG, Shenzhen (CN); Shih-Fang WONG, Tu-Cheng (TW); Lin-Lin GUO, Shenzhen (CN); Pin-Feng FU, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/966,996

(22) Filed: Dec. 29, 2007

(30) Foreign Application Priority Data
Nov. 30, 2007 (CN) 200710202798.8

(51) Int. Cl. G06F 19/00; F16H 59/74

(52) U.S. Cl. 701/112; 477/97

(57) ABSTRACT

An energy saving method for an automobile is provided herein. The energy saving method includes: judging whether the automobile is stopped; starting a timer to measure and signal an end of a predetermined time interval by outputting an interrupt signal; and turning off an engine of the automobile in response to the interrupt signal. A related energy saving device is also provided.

### BACKGROUND

1. Field of the Invention

The present invention relates to automobiles, and particularly to a method and device for saving automobile energy.

2. Description of Related Art

There are lots of traffic in big cities, drivers of the automobiles often obtain stuck in a traffic jam or have to stop their automobiles and wait for a red light for a very long time. However, during the waiting, drivers commonly do not turn off the engine. Thus, wasting energy, such as gasoline, and discharging pollutants into the environment.

Therefore an improved method and device for saving automobile energy are needed to address the aforementioned deficiency and inadequacies.

### SUMMARY

An energy saving method for an automobile is provided herein. The energy saving method includes: judging whether the automobile is stopped; starting a timer to measure and signal an end of a predetermined time interval by outputting an interrupt signal; and turning off an engine of the automobile in response to the interrupt signal. A related energy saving device is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 illustrates a block diagram showing an energy saving device for an automobile in accordance with a first exemplary embodiment.

FIG. 2 illustrates a flowchart of an exemplary process of an energy saving method for an automobile in accordance with the first exemplary embodiment.

FIG. 3 illustrates a block diagram showing an energy saving device for an automobile in accordance with a second exemplary embodiment.

FIG. 4 illustrates a flowchart of an exemplary process of an energy saving method for an automobile in accordance with the second exemplary embodiment.

### DETAILED DESCRIPTION OF THE EMBODIMENTS

Reference will now be made to the drawings to describe a preferred embodiment of the present energy saving method and device for an automobile.

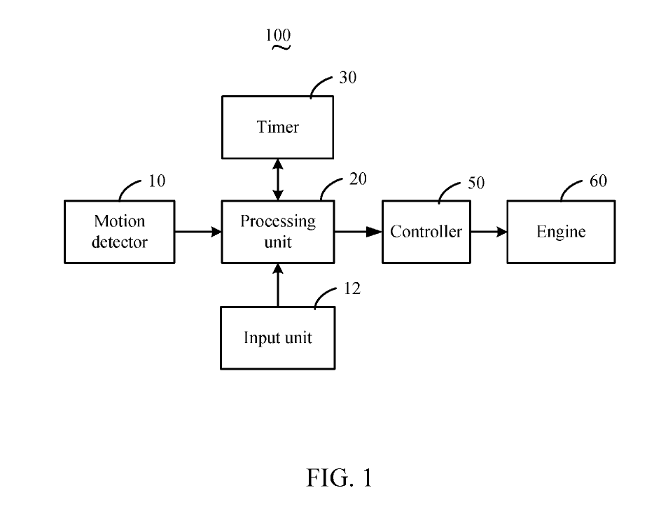

Referring to FIG. 1, an energy saving device 100 for an automobile includes a motion detector 10, a processing unit 20, a timer 30, a controller 50, an engine 60, and an input unit 12. The energy saving device 100 automatically turns off the engine of the automobile when the automobile stops for at least (equal or more than) a predetermined time interval, thus saving energy for the automobile and decreasing a total discharge of motor vehicle exhaust.

The motion detector 10 is configured for detecting and obtaining motion information of the automobile. In the preferred embodiment, the motion information is a speed of the automobile. The timer 30 is configured for measuring and signaling an end of the predetermined time interval by outputting an interrupt signal. The input unit 12 is configured for generating control signals according to input operations. The input unit 12 may be a remote controller, or a keyboard, or a control panel with plurality of buttons disposed in the automobile. In the preferred embodiment, the input unit 12 can generate a setting signal in response to an input operation. The controller 50 is configured for turning on and turning off the engine 60 under control of the processing unit 20. The engine 60 acts as the power unit of the automobile. In the preferred embodiment, the engine 60 is an internal combustion engine that obtains its power by burning a liquid fuel inside an engine cylinder, and generates mechanical energy to drive the automobile.

The processing unit 20 is configured for controlling the controller 50 to turn off the engine when the processing unit 20 computes that the automobile has stopped for at least (equal or more than) the predetermined time interval. In detail, the processing unit 20 receives the speed, and judges whether the speed equals to 0. If the speed equals to 0, that is, the automobile stops, the processing unit 20 generates a trigger signal to start the timer 30, and outputs an off signal to the controller 50 to turn off the engine 60 in response to the interrupt signal. During the predetermined time interval, whenever the speed does not equal to 0, the processing unit 20 outputs a clear signal to reset the timer 30, thus the timer 30 stops timing the predetermined time interval until receiving another trigger signal. The processing unit 20 can further allow the time interval to be adjusted according to the setting signal received from the input unit 12.

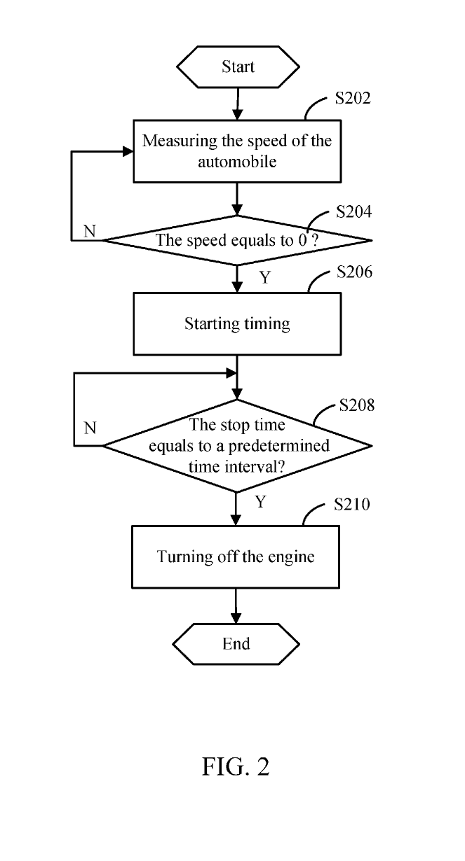

Referring to FIG. 2, a process flow chart for an energy saving method for the automobile is shown in accordance with the first exemplary embodiment. The energy saving method is used for turning off the engine of the automobile when the automobile stops for at least the predetermined time interval, thus saving energy for the automobile and decreasing a total discharge of motor vehicle exhaust. The energy saving method includes the following steps.

In step S202, the motion detector 10 measures the speed of the automobile, and outputs the speed to the processing unit 20.

In step S204, the processing unit 20 judges whether the speed is equal to 0, that is, judging whether the automobile is stopped. If the speed is equal to 0, the process proceeds to step S206, or else, loops back to step S202.

In step S206, the processing unit 20 generates the trigger signal to start the timer 30. As a result, the timer 30 starts timing.

In step S208, if a time interval the timer 30 times reaches to the predetermined time interval, the timer 30 outputs the interrupt signal to the processing unit 20. Or else, the processing unit 20 outputs a clear signal to reset the timer 30 whenever the speed does not equal to 0 during the predetermined time interval.

In step S210, the processing unit 20 generates an off signal in response to the interrupt signal, and outputs the off signal to the controller 50. The controller 50 turns off the engine 60.

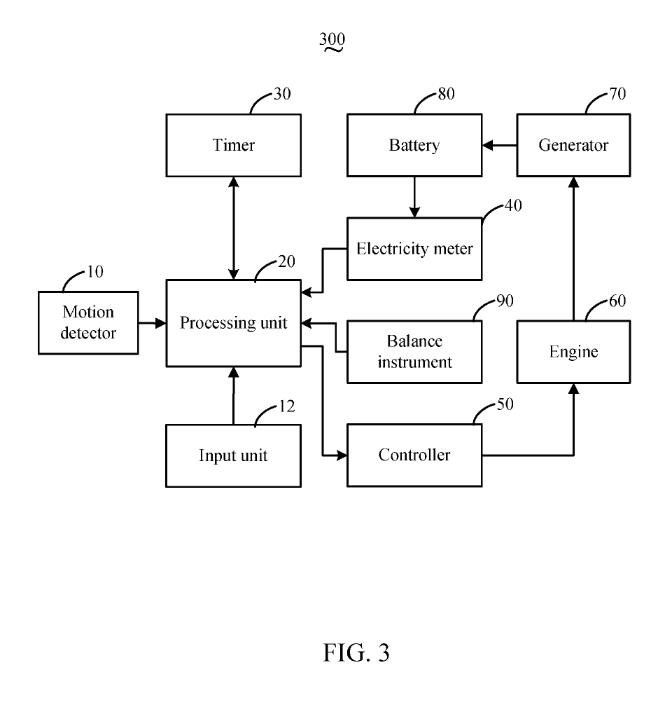

Referring to FIG. 3, in a second exemplary embodiment, an energy saving device 300 for an automobile includes the same motion detector 110, the processing unit 20, the timer 30, the controller 50, the engine 60, and the input unit 12 as FIG. 1. The energy saving device 300 further includes a generator 70, a battery 80, an electricity meter 40, and a balance instrument 90. The energy saving device 300 may also includes an audio and video player, plurality of lighting units, a fuel meter (not shown), etc.

The generator 70 is configured for transforming mechanical energy of the engine 60 into electric energy, and charging/recharging the battery 80. The battery 80 is configured for supplying electric power to other instruments, such as the lighting units, the player, etc. in the automobile. The electricity meter 40 is configured for measuring and displaying a voltage of the battery 80. The balance instrument 90 is configured for measuring an absolute angle of a body or a chassis of the automobile with respect to horizon.

In the preferred embodiment, as so many devices need receiving electric energy from the battery 80, that a sufficient electric energy stored in the battery 80 should be insured. Thus, if the processing unit 20 computes that there is not enough electric energy stored in the battery 80 to maintain the electric operations, that is the voltage of the battery 80 is lower than a predetermined voltage, the processing unit 20 will not output the off signal to turn off the engine 60 when the automobile has stopped for the predetermined time interval. Further, if the processing unit 20 computes that the automobile is stopped on a slope, that is, the absolute angle of the automobile is larger than a predetermined angle, the processing unit 20 will not output the off signal to turn off the engine 60 when the automobile has stopped for the predetermined time interval.

In the other embodiments, the processing unit 20 judges whether the automobile is on the slope, and/or whether the electric energy stored in the battery 80 is sufficient first. If the automobile is not on a slope, and/or the electric energy stored in the battery 80 is sufficient, the processing unit 20 then judges whether the automobile is stopped.

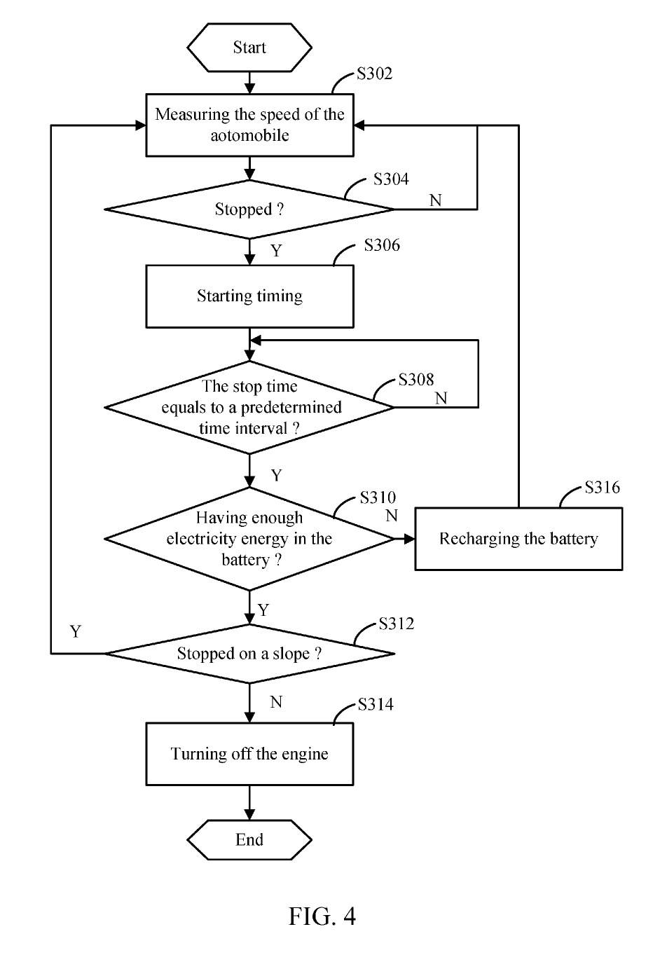

Referring to FIG. 4, a process flow chart for an energy saving method for the energy saving device 300 is shown in accordance with the second exemplary embodiment. The energy saving method is used for turning off the engine of the automobile when the automobile stops for the predetermined time interval, thus saving energy for the automobile and decreasing a total discharge of motor vehicle exhaust. The energy saving method includes the following steps.

In step S302, the motion detector 10 measures the speed of the automobile, and outputs the speed to the processing unit 20.

In step S304, the processing unit 20 judges whether the speed is equal to 0, that is, judging whether the automobile is stopped. If the speed is equal to 0, the process loops back to step S302, or else, proceeds to step S306.

In step S306, the processing unit 20 generates a trigger signal to start the timer 30. As a result, the timer 30 starts timing.

In step S308, if a time the timer 30 times reaches to the predetermined time interval, the timer 30 outputs an interrupt signal to the processing unit 20. Or else, the processing unit 20 outputs a clear signal to reset the timer 30 whenever the speed does not equal to 0 during the predetermined time interval.

In step S310, the processing unit 20 judges whether the voltage of the battery 80 is larger than the predetermined voltage. If the voltage of the battery 80 is larger than the predetermined voltage, the process proceeds to step S312, or else, proceeds to step S316.

In step S312, the processing unit 20 judges whether the automobile is stopped on a slope, that is, the absolute angle of the automobile is larger than the predetermined angle. If the automobile is indeed stopped on a slope, the process loops back to step S302, or else, proceeds to step S314.

In step S314, the processing unit 20 outputs the off signal to the controller 50. The controller 50 turns off the engine 60.

In step S316, the generator 70 transforms mechanical energy of the engine 60 into electric energy, and recharges the battery 80. The process loops back to step S302.

In the above-described preferred embodiments, when the energy saving device 300 computes that the automobile has been stopped (not on a slope) for the predetermined time interval (3 minutes for example), and the battery 80 has enough electric energy, the energy saving device 300 will turns off the engine 60, thus saving energy for the automobile and decreasing a total discharge of motor vehicle exhaust.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An energy saving method for an automobile, comprising:
judging whether the automobile is stopped;
starting a timer to measure and signal an end of a predetermined time interval by outputting an interrupt signal; and
turning off an engine of the automobile in response to the interrupt signal.

2. The energy saving method as described in claim 1, wherein the method for judging whether the automobile is stopped is to measure a speed of the automobile, if the speed equals to 0, the automobile is considered to be stopped.

3. The energy saving method as described in claim 2, further comprising resetting the timer if the speed is no longer equal to 0 during the predetermined time interval.

4. The energy saving method as described in claim 3, further comprising judging whether the automobile is on a slope; if determining that the automobile is not on a slope, judging whether the automobile is stopped.

5. The energy saving method as described in claim 3, further comprising judging whether an electric energy is larger than a predetermined value; if determining that the electric energy is larger than the predetermined value, judging whether the automobile is stopped.

6. An energy saving method for an automobile, comprising:
judging whether the automobile is stopped;
starting a timer to measure and signal an end of a predetermined time interval by outputting an interrupt signal;
judging whether the automobile is stopped on a slope in response to the interrupt signal;
turning off an engine of the automobile if the automobile is not stopped on a slope.

7. The energy saving method as described in claim 6, further comprising judging whether an electric energy is larger than a predetermined value in response to the interrupt signal; if determining that the electric energy is larger than the predetermined value, judging whether the automobile is stopped on a slope.

8. The energy saving method as described in claim 7, wherein the method for judging whether the automobile is stopped is to measure a speed of the automobile, if the speed equals to 0, the automobile is considered to be stopped.

9. The energy saving method as described in claim 7, wherein the method for judging whether the automobile is stopped on a slope is to measure an absolute angle of the automobile with respect to horizon, if the absolute angle is larger than a predetermined angle, the automobile is considered to be on a slope.

10. The energy saving method as described in claim 7, wherein the method for judging an electric energy is to measure a voltage of a battery of the automobile.

11. The energy saving method as described in claim 10, further comprising recharging the battery if the electric energy is lower than or equal to the predetermined value.

12. The energy saving method as described in claim 6, further comprising resetting the timer if the speed is no longer equal to 0 during the predetermined time interval.

13. An energy saving device for an automobile with an engine, comprising:
a motion detector for detecting and obtaining motion information of the automobile;
a timer for measuring and signaling an end of a predetermined time interval by outputting an interrupt signal;
a controller for turning on and off the engine;
a processing unit for starting the timer if the automobile is stopped according to the motion information, and outputting an off signal to control the controller to turn off the engine in response to the interrupt signal.

14. The energy saving device as described in claim 13, wherein the motion information comprising a speed of the automobile.

15. The energy saving device as described in claim 13, further comprising an input unit for generating a setting signal in response to an input operation; the processing unit is further used for allowing the time interval to be set and modified according to the setting signal.

16. The energy saving device as described in claim 13, wherein the engine is an internal combustion engine.

17. The energy saving device as described in claim 13, further comprising a battery, and a generator for transforming mechanical energy of the engine into electric energy and recharging the battery; the processing unit judges whether the automobile is stopped when it computes that there is sufficient electric energy.

18. The energy saving device as described in claim 13, further comprising a balance instrument for measuring an absolute angle of the automobile with respect to horizon; the processing unit judges whether the automobile is stopped when it computes that the automobile is not on a slope.
